(19) United States
(12) Patent Application Publication
(10) Pub. No.: US 2026/0257728 A1
(43) Pub. Date: Sep. 3, 2026

(54) VEHICLE UNDER BODY STRUCTURE

(71) Applicant: Nissan Motor Co., Ltd., Yokohama-shi (JP)

(72) Inventors: Tsuguhiro KAWASAKI, Kanagawa (JP); Kouji NOUNO, Kanagawa (JP); Masahiro TAMURA, Kanagawa (JP)

(21) Appl. No.: 19/550,706

(22) Filed: Feb. 26, 2026

(30) Foreign Application Priority Data
Feb. 28, 2025 (JP) 2025-031643

(51) Int. Cl. B62D 21/15; B60K 1/04; B62D 21/02

(52) U.S. Cl. CPC B62D 21/157; B60K 1/04; B62D 21/02; B60K 2001/0438

(57) ABSTRACT

A vehicle underbody structure is provided to suppress interference of vehicle structures with the battery case during a side collision. The vehicle underbody structure includes a floor panel, a pair of side sills, a cross member and the battery case. The floor panel constitutes a floor surface of a vehicle. The pair of side sills are arranged on left and right sides of the floor panel. The cross member is provided on an exterior surface of the floor panel and includes a flat extending bottom surface. The cross member extends in a vehicle width direction to connect the pair of side sills. The battery case is disposed below the floor panel and the cross member and accommodates a battery. A vulnerable site is provided in a lower portion of the cross member in a cross section perpendicular to an extending direction of the cross member.

### CROSS REFERENCE TO RELATED APPLICATIONS

This application claims priority under 35 U.S.C. § 119 to Japanese Patent Application No. 2025-031643 filed on Feb. 28, 2025, the entire disclosure of Japanese Patent Application No. 2025-031643 is hereby incorporated herein by reference.

### BACKGROUND

### Technical Field

The present invention relates to the structure of a vehicle, primarily the under portion (underbody).

### Background Information

One known vehicle underbody structure of this type is a vehicle body lateral section structure comprising: a side sill formed by joining a side sill inner and a side sill outer at upper and lower end portions in the vehicle height direction; a battery pack disposed in a lower portion of the vehicle body on the interior side of the side sill in the vehicle width direction; and a floor cross member extending in the vehicle width direction above the side sill on the interior side of the side sill in the vehicle width direction (International Publication WO 2023/233930 pamphlet). In this conventional vehicle body lateral section structure, when a collision load is applied to the side sill from the interior side of the side sill in the vehicle width direction (side collision), the side sill outer deforms and collapses, and then the load applied to the side sill is transferred to the floor cross member, thereby reducing the load transferred to the battery pack.

The above conventional technique, however, poses a problem in that when the floor cross member undergoes downward convex buckling deformation, vehicle structures such as the floor panel interfere with the battery case.

### SUMMARY

A problem to be solved by the present invention is to provide a vehicle underbody structure that can suppress the interference of vehicle structures with a battery case during a side collision.

The present invention solves the above problem in a vehicle underbody structure comprising: a cross member that is provided on an exterior surface of the floor panel, includes a flat extending bottom surface, and extends in a vehicle width direction to connect the pair of side sills; and a battery case that is disposed below the floor panel and the cross member and accommodates a battery, by providing a vulnerable site in a lower portion of the cross member in a cross section perpendicular to an extending direction of the cross member.

According to the present invention, it is possible to suppress the interference of vehicle structures with a battery case during a side collision.

### BRIEF DESCRIPTION OF DRAWINGS

Referring now to the attached drawings which form a part of this original disclosure, illustrated embodiments are shown.

FIG. 1 is a bottom view of a vehicle illustrating a vehicle underbody structure according to an embodiment of the present invention;

FIG. 2 is an exploded perspective view illustrating the floor panel, side sills, and cross member of FIG. 1;

FIG. 3 is a cross-sectional view illustrating an upside-down cross section taken along line III-III of FIG. 1;

FIG. 4 is a cross-sectional view taken along line IV-IV of FIG. 3;

FIGS. 5A to 5C are each a partially cutaway perspective view illustrating part V of FIG. 3;

FIG. 6 is a cross-sectional view illustrating an upside-down cross section taken along line III-III of FIG. 1, illustrating a vehicle underbody structure according to another embodiment of the present invention;

FIG. 7 is a cross-sectional view illustrating an upside-down cross section taken along line III-III of FIG. 1, illustrating a vehicle underbody structure according to still another embodiment of the present invention;

FIGS. 8A and 8B are each a perspective view illustrating part VIII of FIG. 7;

FIG. 9 is a cross-sectional view illustrating an upside-down cross section taken along line III-III of FIG. 1, illustrating a vehicle underbody structure according to yet another embodiment of the present invention;

FIG. 10 is a perspective view illustrating part X of FIG. 9;

FIGS. 11A and 11B are each a diagram for describing an action of the embodiment illustrated in FIG. 1;

FIG. 12A is a diagram for describing an action of the embodiment illustrated in FIG. 7; and

FIG. 12B is a diagram for describing an action of a comparative example.

### DETAILED DESCRIPTION OF EMBODIMENTS

### Common Configuration of Embodiments

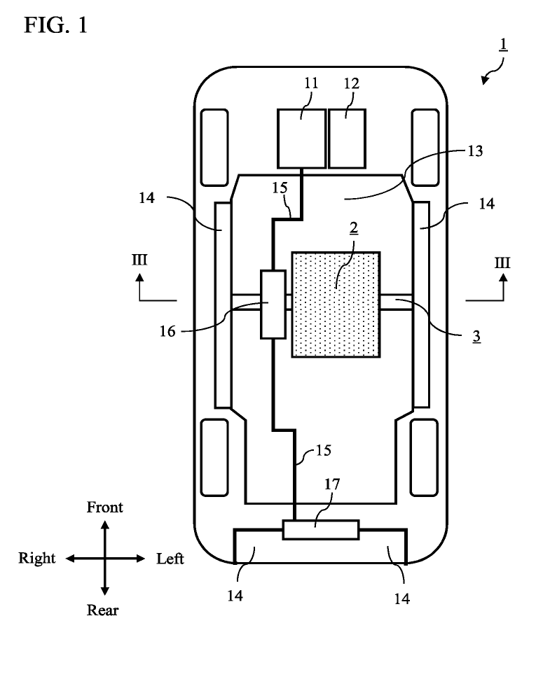

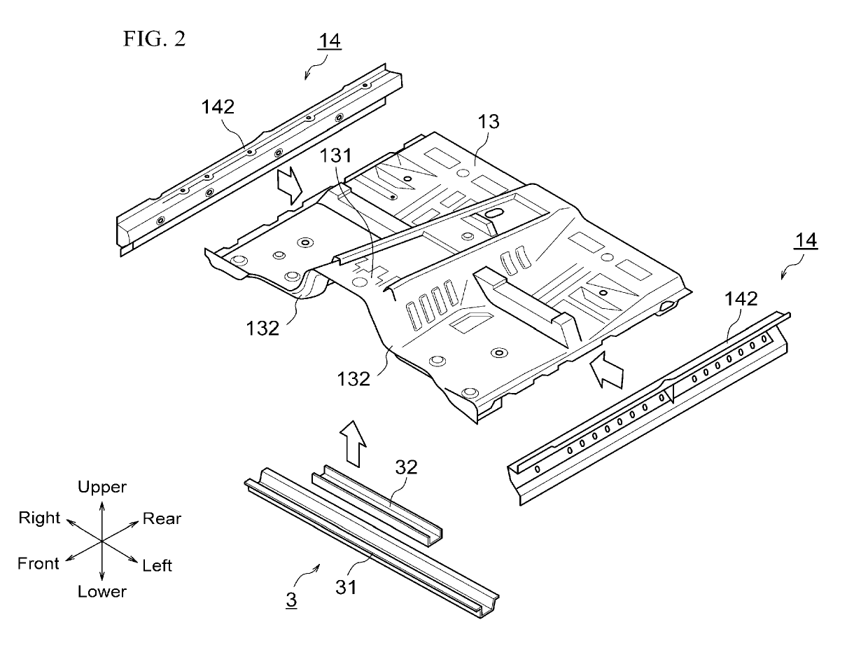

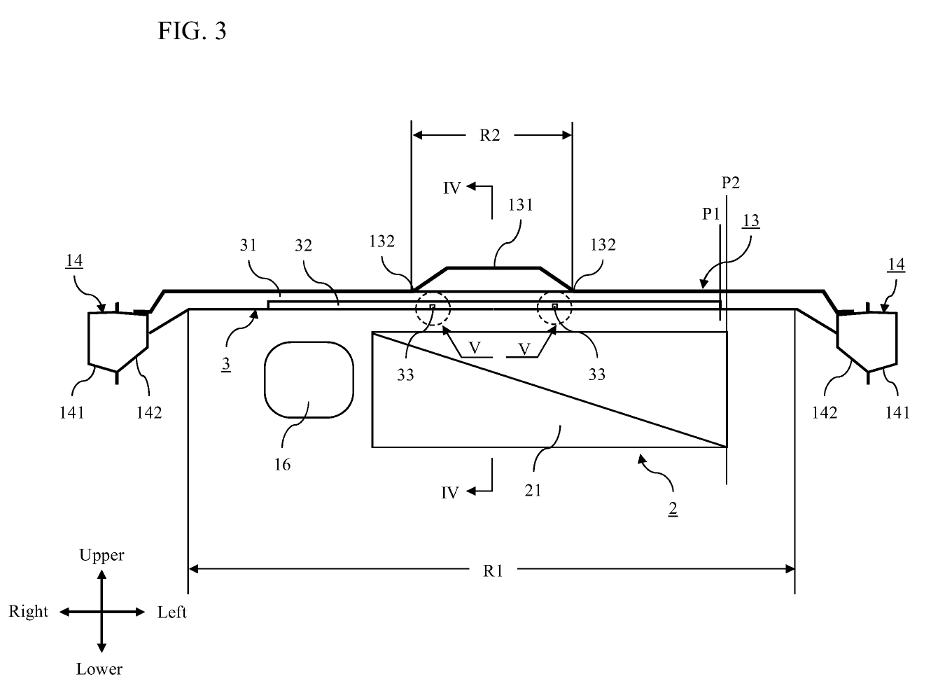

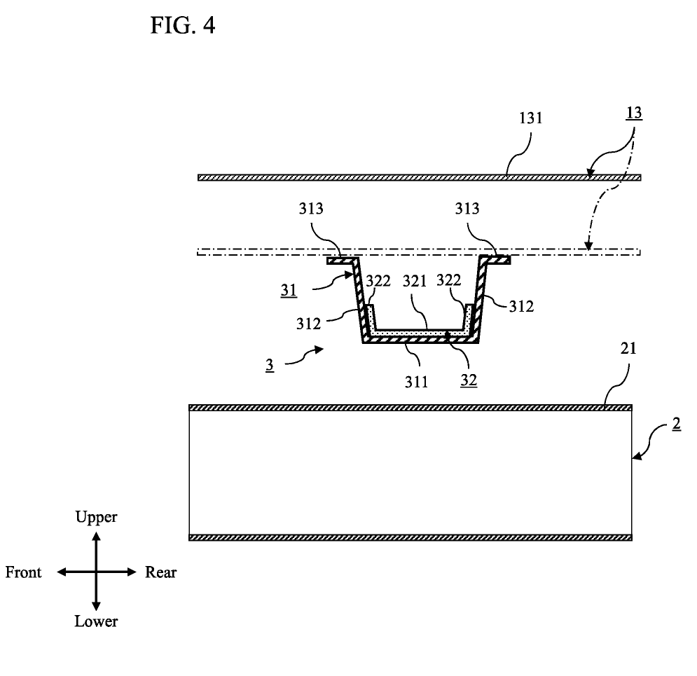

Hereinafter, one or more embodiments of the present invention will be described with reference to the drawings. FIG. 1 is a bottom view of a vehicle 1 illustrating the lower portion structure of the vehicle 1 according to an embodiment of the present invention, FIG. 2 is an exploded perspective view illustrating a floor panel 13, side sills 14, and a cross member 3 of FIG. 1, FIG. 3 is an upside-down cross-sectional view taken along line III-III of FIG. 1, and FIG. 4 is a cross-sectional view taken along line IV-IV of FIG. 3.

As illustrated in FIG. 1, the vehicle 1 of the present embodiment has an internal combustion engine 11 and a drive motor 12. The type of vehicle 1 of the present embodiment is not particularly limited, and it may be a hybrid vehicle using both the internal combustion engine 11 and the drive motor 12 as drive sources, or it may be a hybrid vehicle using only the drive motor 12 as a drive source and the internal combustion engine 11 as a power source for generating electricity. In the following embodiments, the present invention will be described by exemplifying a hybrid vehicle, but the vehicle of the present invention may also be an electric automobile equipped only with the drive motor 12, without the internal combustion engine 11.

The vehicle 1 of the present embodiment includes a vehicle underbody structure (also referred to as an automobile underbody structure) that includes a floor panel 13, a pair of left and right side sills 14, a battery 2, and a cross member 3. The vehicle according to the present invention may also include other underbody components. In the following description, the direction along the front-to-rear of the vehicle 1 will be referred to as the front-to-rear direction, the direction along the left-to-right direction of the vehicle 1 will be referred to as the vehicle width direction, and the direction along the up-to-down direction of the vehicle 1 will be referred to as the up-to-down direction. The front-to-rear, left-to-right, and up-to-down directions of the vehicle 1 are illustrated in each of FIGS. 1 to 12B.

As illustrated in FIGS. 1 and 2, the floor panel 13 is a press-formed member made of metal sheet material that forms the floor surface of the vehicle cabin. To increase the panel rigidity against inputs in the front-to-rear direction of the vehicle 1, as illustrated in FIGS. 2 and 3, the floor panel 13 is formed with a tunnel portion 131 that extends along the front-to-rear direction of the vehicle 1 at the center in the vehicle width direction of the vehicle 1 and bends upward in a convex shape. The boundary portions between the general surface of the floor panel 13 and the tunnel portion 131 are also referred to as rising start positions 132.

As illustrated in FIG. 3, the side sills 14 are each an assembly composed of a sill outer panel 141 and a sill inner panel 142 welded together to form a hollow structure, and are fixed to the left and right end portions of the floor panel 13 by welding or other methods. The sill outer panel 141 and sill inner panel 142 that constitute each side sill 14 are press-formed from metal sheet material. These panels have high longitudinal rigidity within the vehicle structure and constitute part of the underbody structure of the vehicle 1. The side sills 14 are provided on respective left and right end portions of the floor panel 13, extending from the rear portions of the front wheels to the front portions of the rear wheels.

The battery 2 is configured to accommodate cell modules in a battery case 21. As illustrated in FIGS. 1 and 3, the battery 2 is disposed on the exterior side (underfloor side) of the floor panel 13 via a battery frame (not illustrated), below the cross member 3. The battery 2 supplies power to the drive motor 12, on-board electrical equipment, etc.

The internal combustion engine 11 has an exhaust pipe 15 that guides exhaust gases. As illustrated in FIG. 1, the exhaust pipe 15 extends from the internal combustion engine 11, which is mounted in the front portion of the vehicle 1, toward the rear of the vehicle 1, and its portion is routed in the space between the battery 2 and the right-side side sill 14. A first silencer 16 and a second silencer 17 are provided midway along the exhaust pipe 15. The first silencer 16 is disposed between the battery 2 and the right-side side sill 14. The first silencer 16 and the second silencer 17 may each include a filter unit or a catalyst unit. The second silencer 17 is not necessarily required, and only the first silencer 16 may be disposed. Furthermore, the battery 2 and the first silencer 16 may be disposed in reverse left-right positions.

The cross member 3 of the present embodiment is configured to include a cross member main body 31 and a reinforcing member 32. The cross member main body 31 is provided on the exterior surface of the floor panel 13, includes a flat extending bottom surface 311, and extends in the vehicle width direction to connect the pair of side sills 14 and 14. The reinforcing member 32 extends in the vehicle width direction on the flat extending bottom surface 311.

The cross member main body 31 of the present embodiment is a skeletal member formed by pressing a metal sheet. As illustrated in the cross-sectional view of FIG. 4, the cross member main body 31 has a bottom surface 311, vertical wall surfaces 312 and 312 rising from the bottom surface 311, and flange surfaces 313 that are folded horizontally from the upper ends of respective vertical wall surfaces 312. The bottom surface 311 extends flat in the range indicated by a symbol R1 in FIG. 3, and slopes toward the sill inner panel 142 in the outer range beyond that. Here, “extending flat” means that the bottom surface 311 does not curve or bend, but extends horizontally or slightly inclined over at least all or part of the specified range R1. In other words, this means that the cross member main body 31 includes a shape or structure that may cause the cross member main body 31 to undergo downward convex buckling deformation when a side collision load is input. By including the flat extending bottom surface 311 over all or part of the specified range R1, the rigidity of the vehicle 1 against a side collision in which an input load is applied in the vehicle width direction can be increased.

The cross member main body 31 of the present embodiment may be sufficient as long as the bottom surface 311 extends flat over the specified range R1. The upper ends of the flange surfaces 313 and the vertical wall surfaces 312 may extend flat like the bottom surface 311, as illustrated in FIGS. 2 and 3, or may instead extend curvedly along the underside of the floor panel 13.

The reinforcing member 32 of the present embodiment is a skeletal member formed by pressing a metal sheet. As illustrated in the cross-sectional view of FIG. 4, the reinforcing member 32 has a bottom surface 321 and vertical wall surfaces 322 rising from the bottom surface 321. As illustrated in FIG. 3, the reinforcing member 32 of the present embodiment is joined by welding or the like in a state in which the bottom surface 321 of the reinforcing member 32 is in contact with the bottom surface 311 of the cross member main body 31 within the range R1 of the flat bottom surface 311 of the cross member main body 31. The reinforcing member 32 of the present invention may also be a flat sheet-like member composed only of the bottom surface 321, without the vertical wall surfaces 322.

As illustrated in FIG. 3, the reinforcing member 32 of the present embodiment is provided such that its center coincides with the center of the vehicle in the vehicle width direction, and its left end position P1 is positioned inward of an outer left end position P2 of the battery case 21, that is, closer to the center in the vehicle width direction. This allows the side sill 14 and the left end portion of the cross member main body 31 to sufficiently crush in the event of a vehicle width input, such as a side collision, and absorb the collision energy while preventing the cross member 3 from prematurely initiating buckling deformation in the early stages of the side collision. If the battery case 21 and the first silencer 16 are reversed, it is preferred to provide the reinforcing member 32 such that its right end position is positioned inward of an outer right end position of the battery case 21, that is, closer to the center in the vehicle width direction.

The cross member 3 is provided with a vulnerable site 33 in a lower portion of the cross member 3 in a cross section perpendicular to the extending direction of the cross member 3. The vulnerable site 33 has a smaller buckling deformation load in response to an input in the vehicle width direction than the upper portion. The vulnerable site 33 of the present embodiment refers to a shape and structure that causes the cross member 3 to buckle upwardly convexly from the vulnerable site 33 as a starting point when a load in the vehicle width direction, that is, a side collision load, is applied to the vehicle 1.

The vulnerable site 33 of the present embodiment is more preferably provided inward in the vehicle width direction from a rising start position 132 of the tunnel portion 131 of the floor panel 13, that is, in a range indicated by a symbol R2, as illustrated in FIG. 3. This is because the upward convex buckling deformation of the floor panel 13 complements the upward convex buckling deformation of the entire cross member 3 in the event of a side collision or other input. Some exemplary forms the vulnerable site 33 of the present invention will be described below.

### First Exemplary Form of Vulnerable Site

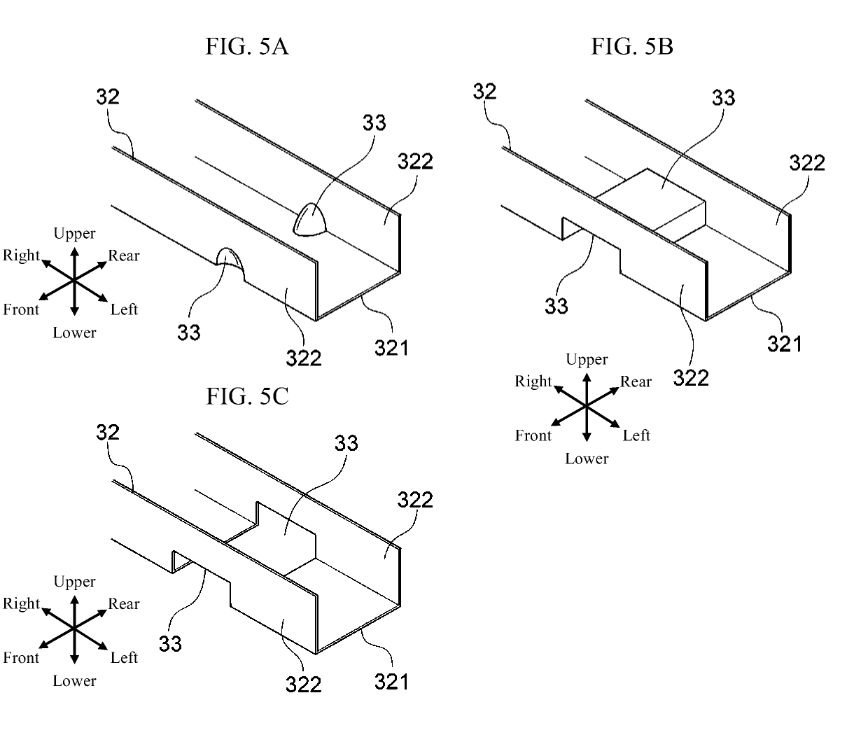

FIGS. 5A to 5C are each a partially cutaway perspective view illustrating one of parts V of FIG. 3. The vulnerable sites 33 illustrated in FIGS. 5A to 5C are all examples provided on the reinforcing member 32. The vulnerable site 33 in FIG. 5A is an example in which the ridge between the bottom surface 321 and each vertical wall surface 322 of the reinforcing member 32 is recessed to form a triangular bead-shaped recess. The vulnerable site 33 in FIG. 5B is an example in which the bottom surface 321 of the reinforcing member 32 is embossed to form an upward convex shape. The vulnerable site 33 in FIG. 5C is an example in which an opening is formed by cutting out the lower sides of the bottom surface 321 and vertical wall surfaces 322 of the reinforcing member 32. In any of the examples, the reinforcing member 32 is formed with a vulnerable site 33 in a lower portion of the reinforcing member 32 in a cross section perpendicular to the extending direction of the cross member 3, and the vulnerable site 33 has a smaller buckling deformation load in response to an input in the vehicle width direction than the upper portion.

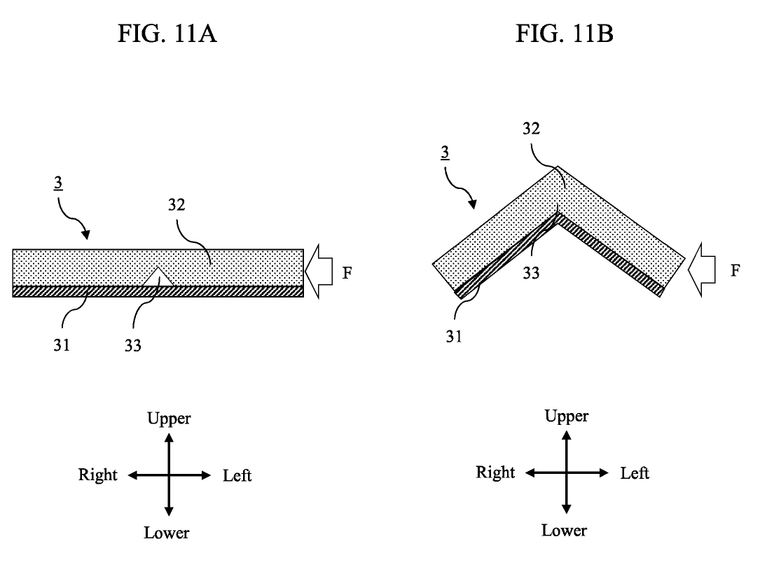

The action will now be described. FIGS. 11A and 11B are each a diagram for describing the action of the embodiment illustrated in FIG. 1. As illustrated in FIG. 11A, when a force F in the vehicle width direction is input to the cross member 3, such as in a side collision, since the reinforcing member 32 is formed with a vulnerable site 33 in a lower portion of the reinforcing member 32 in a cross section perpendicular to the extending direction of the cross member 3 and the vulnerable site 33 has a smaller buckling deformation load in response to an input in the vehicle width direction than the upper portion, the reinforcing member 32 undergoes upward convex buckling deformation as illustrated in FIG. 11B. The cross member main body 31 also undergoes upward convex buckling deformation simultaneously with the buckling deformation of the reinforcing member 32 because the cross member main body 31 is welded to the reinforcing member 32. In addition, although not illustrated, since the floor panel 13 is welded to the cross member main body 31, it also undergoes upward convex buckling deformation. As a result of this deformation, the cross member (cross member main body 31 and reinforcing member 32) above the battery case 21 and the floor panel 13 both undergo upward convex buckling deformation so as to move away from the battery case 21. As a result, the interference of vehicle structures with the battery case 21 during a side collision can be suppressed.

### Second Exemplary Form of Vulnerable Site

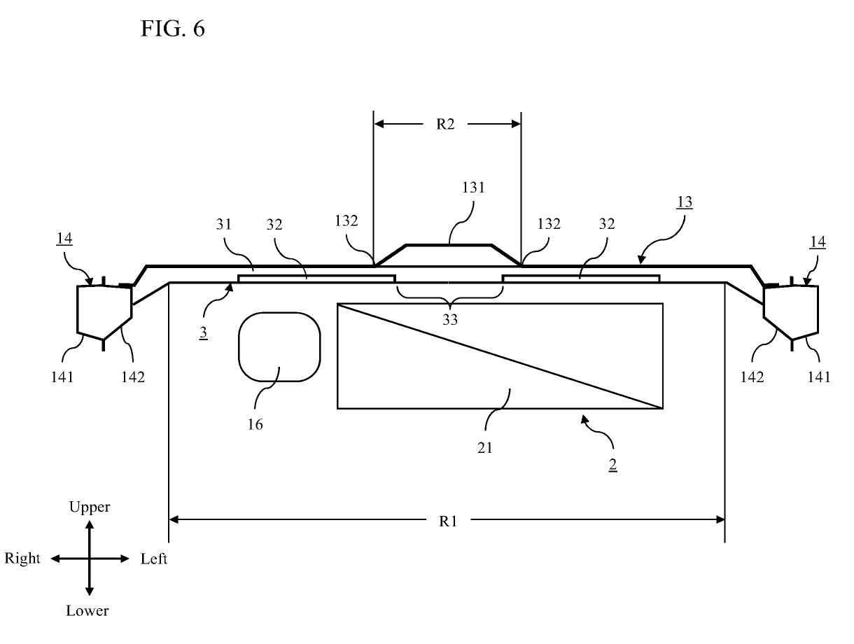

FIG. 6 is a cross-sectional view illustrating an upside-down cross section taken along line III-III of FIG. 1, illustrating a vehicle 1 underbody structure according to another embodiment of the present invention. In the first embodiment illustrated in FIGS. 3 and 5A to 5C, a single reinforcing member 32 is provided on the cross member main body 31, and a vulnerable site 33 is formed in that reinforcing member 32, but in the second exemplary form illustrated in FIG. 6, alternatively, two reinforcing members 32 and 32 are provided spaced apart on the left and right in the vehicle width direction, and the space between these two reinforcing members 32 and 32 (i.e., the portion of the cross member 3 on which no reinforcing member 32 is provided) is designated as the vulnerable site 33.

The configuration of the cross member main body 31 in this case is the same as that of the cross member main body 31 in the embodiment illustrated in FIGS. 2 to 4. As illustrated in the cross-sectional view of FIG. 4, each reinforcing member 32 has a bottom surface 321 and vertical wall surfaces 322 rising from the bottom surface 321. As illustrated in FIG. 6, each reinforcing member 32 of the present embodiment is joined by welding or the like in a state in which the bottom surface 321 of the reinforcing member 32 is in contact with the bottom surface 311 of the cross member main body 31 in the range R1 of the flat bottom surface 311 of the cross member main body 31. The reinforcing member 32 according to the present invention may be a flat sheet-like member composed only of the bottom surface 321, without the vertical wall surfaces 322.

Note, however, that in the present embodiment, each reinforcing member 32 itself does not have a vulnerable site 33; instead, the space between these two reinforcing members 32 and 32 serves as the vulnerable site 33. Here, it is more preferred to provide the inner end portions of the two reinforcing members 32 more inward in the vehicle width direction than the rising start positions 132 of the tunnel portion 131 of the floor panel 13, as illustrated in FIG. 6 , that is, in the range indicated by the symbol R2.

As illustrated in FIG. 6, when the two reinforcing members 32 are provided spaced apart on the left and right of the cross member main body 31 in the vehicle width direction, and the space between the reinforcing members 32 and 32 is designated as the vulnerable site 33, the buckling deformation load of the entire cross member 3 in response to the input in the vehicle width direction, such as in a side collision, will be relatively smaller in the space between the two reinforcing members 32 and 32, that is, the portion of the cross member main body 31 without the reinforcing member 32, than in the portion provided with the reinforcing member 32. Furthermore, because the two reinforcing members 32 and 32 are provided in the lower portion of the cross member main body 31, the buckling deformation load of the entire cross member 3 will be relatively smaller in the lower portion in a cross section perpendicular to the extending direction of the cross member than in the upper portion. As a result, when a force F is input in the vehicle width direction, such as in a side collision, the reinforcing member 32 undergoes upward convex buckling deformation from the vulnerable site 33 as a starting point, particularly from the inner end portion of the reinforcing member 32 at which the magnitude of the buckling deformation load changes rapidly. This can suppress the interference of vehicle structures with the battery case 21 during a side collision.

### Third Exemplary Form of Vulnerable Site

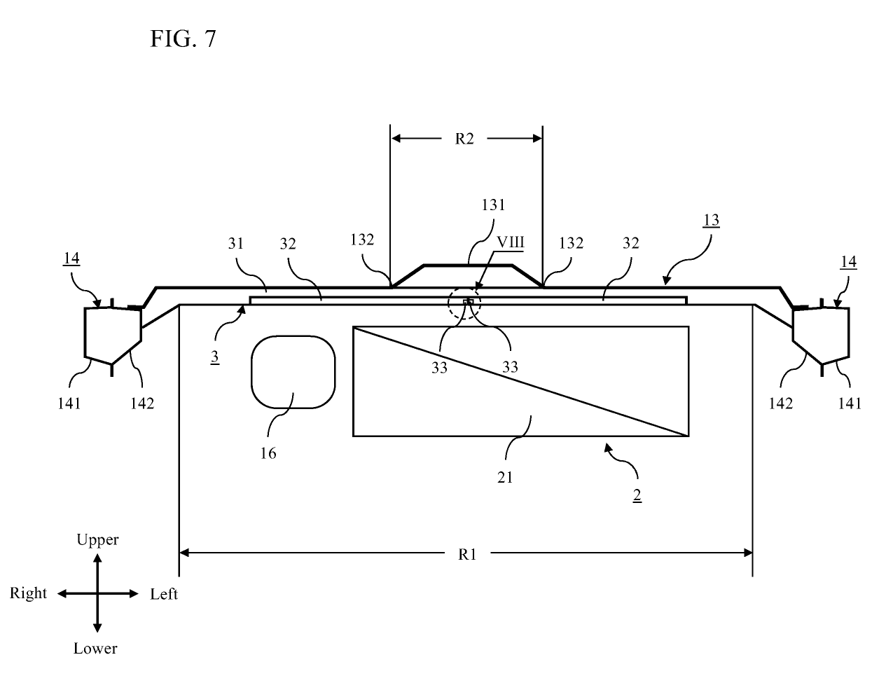

FIG. 7 is a cross-sectional view illustrating an upside-down cross section taken along line III-III of FIG. 1, illustrating a vehicle 1 underbody structure according to still another embodiment of the present invention. In the first embodiment illustrated in FIGS. 3 and 5A to 5C, a single reinforcing member 32 is provided on the cross member main body 31, and a vulnerable site 33 is formed in that reinforcing member 32, but in the third exemplary form illustrated in FIG. 7, alternatively, two reinforcing members 32 and 32 are provided in contact with each other on the left and right in the vehicle width direction, and vulnerable sites 33 are provided in respective end portions of these two reinforcing members 32 and 32 in contact with each other.

The configuration of the cross member main body 31 in this case is the same as that of the cross member main body 31 in the embodiment illustrated in FIGS. 2 to 4. As illustrated in the cross-sectional view of FIG. 4, each reinforcing member 32 has a bottom surface 321 and vertical wall surfaces 322 rising from the bottom surface 321. As illustrated in FIG. 7, each reinforcing member 32 of the present embodiment is joined by welding or the like in a state in which the bottom surface 321 of the reinforcing member 32 is in contact with the bottom surface 311 of the cross member main body 31 in the range R1 of the flat bottom surface 311 of the cross member main body 31. The reinforcing member 32 according to the present invention may be a flat sheet-like member composed only of the bottom surface 321, without the vertical wall surfaces 322.

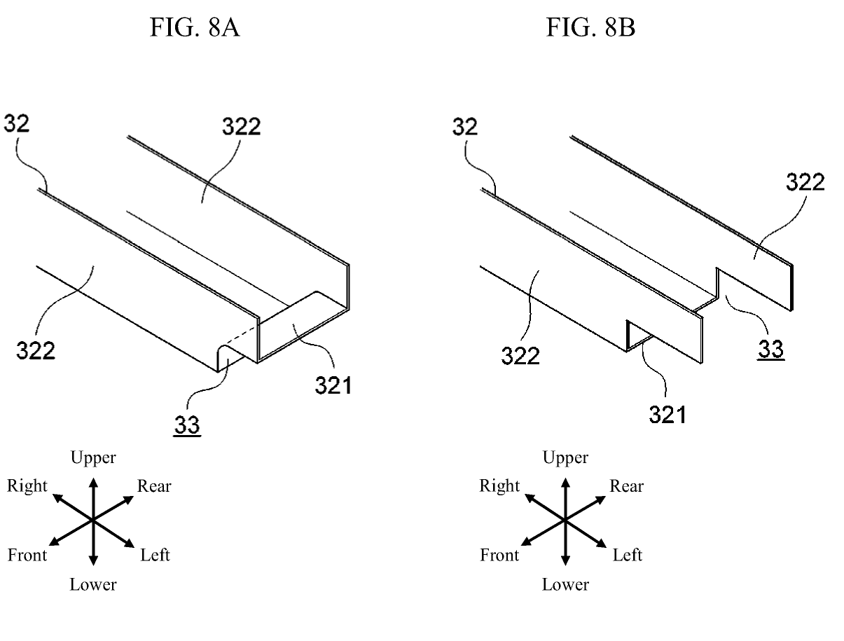

FIGS. 8A and 8B are each a perspective view illustrating part VIII of FIG. 7, illustrating the inner end portion of one reinforcing member 32. The vulnerable site 33 in FIG. 8A is an example in which the bottom surface 321 of the inner end portion of the reinforcing member 32 is embossed in an upward convex shape. The vulnerable site 33 in FIG. 8B is an example in which the bottom surface 321 of the inner end portion of the reinforcing member 32 and the lower portions of the vertical wall surfaces 322 are cut out. In both examples, the reinforcing member 32 is formed with a vulnerable site 33 in a lower portion of the reinforcing member 32 in a cross section perpendicular to the extending direction of the cross member 3, and the vulnerable site 33 has a smaller buckling deformation load in response to an input in the vehicle width direction than the upper portion.

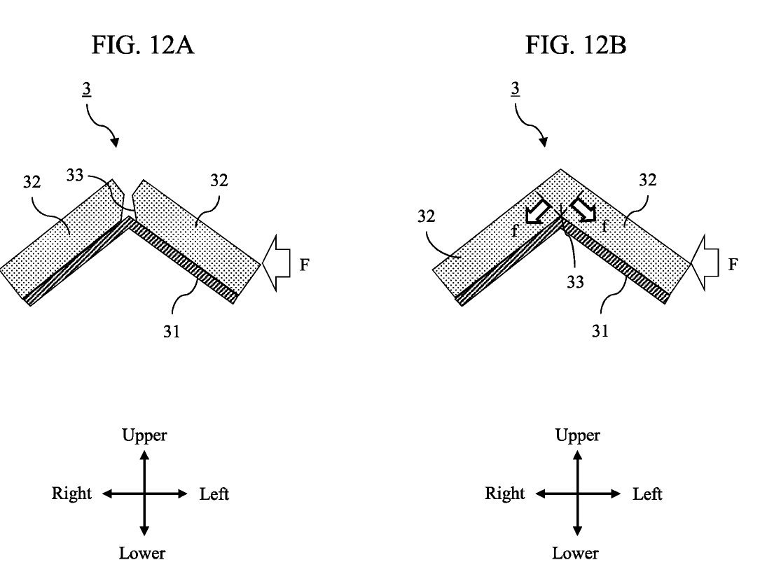

The action will then be described. FIG. 12A is a diagram for describing the action of the embodiment illustrated in FIGS. 7 and 12B is a diagram for describing an action of the embodiment illustrated in FIG. 1 as a comparative example to the embodiment illustrated in FIG. 7. As illustrated in FIG. 12A, when a force F in the vehicle width direction, such as in a side collision, is input to the cross member 3, the two reinforcing members 32 undergo upward convex buckling deformation at the contact point, starting from the vulnerable site 33 in which the buckling deformation load in response to an input in the vehicle width direction is smaller than that in the upper portion.

If the reinforcing member 32 is composed of a single reinforcing member 32 as in the comparative example illustrated in FIG. 12B, buckling deformation starting from the vulnerable site 33 generates a tensile force f in the upper portion of the reinforcing member 32, which may prevent smooth buckling deformation. In contrast, in the present embodiment illustrated in FIG. 12A, the two reinforcing members 32 and 32 are merely in contact with each other but are not joined, so no tensile force f is generated between these two reinforcing members 32 and 32. As such, the buckling deformation can be more reliably achieved at the intended position compared to the comparative example illustrated in FIG. 12B.

When the two reinforcing members 32 undergo upward convex buckling deformation as illustrated in FIG. 12A, each cross member main body 31 also undergoes upward convex buckling deformation simultaneously with the buckling deformation of the reinforcing member 32 because the cross member main body 31 is welded to the reinforcing member 32. In addition, although not illustrated, since the floor panel 13 is welded to the cross member main body 31, it also undergoes upward convex buckling deformation. As a result of this deformation, the cross member (cross member main body 31 and reinforcing member 32) above the battery case 21 and the floor panel 13 both undergo upward convex buckling deformation so as to move away from the battery case 21. As a result, the interference of vehicle structures with the battery case 21 during a side collision can be suppressed.

### Fourth Exemplary Form of Vulnerable Site

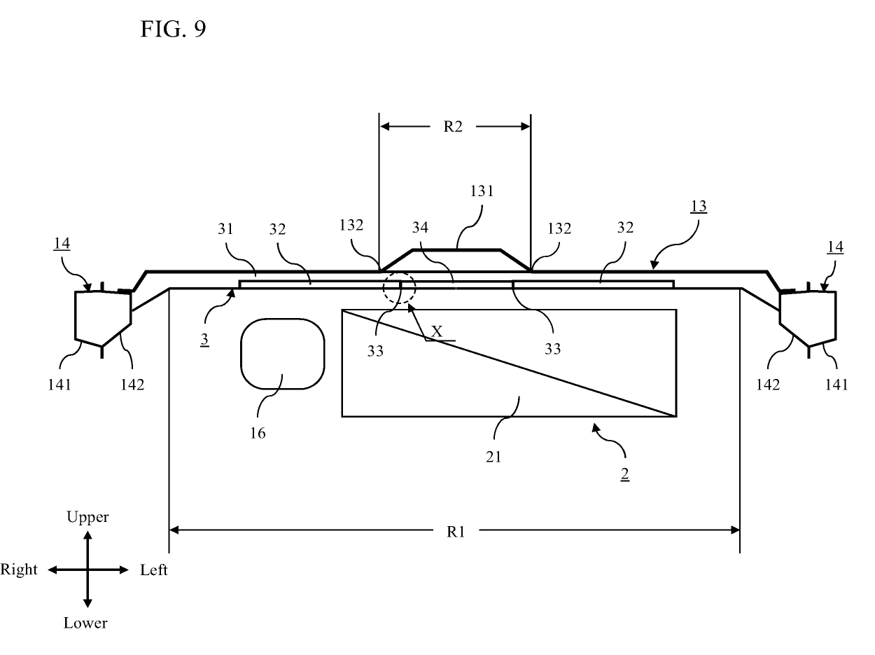

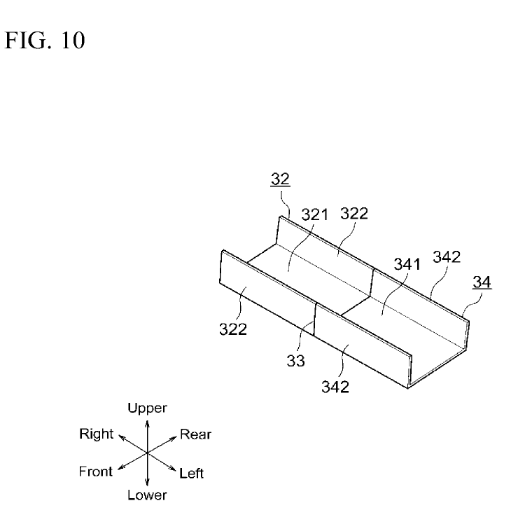

FIG. 9 is a cross-sectional view illustrating an upside-down cross section taken along line III-III of FIG. 1, illustrating a vehicle 1 underbody structure according to yet another embodiment of the present invention, and FIG. 10 is a perspective view of pat X in FIG. 9. In the first embodiment illustrated in FIGS. 3 and 5A to 5C, a single reinforcing member 32 is provided on the cross member main body 31, and a vulnerable site 33 is formed in that reinforcing member 32, but in the fourth exemplary form illustrated in FIG. 9, alternatively, two reinforcing members 32 and 32 are provided spaced apart on the left and right in the vehicle width direction, and an intermediate reinforcing member 34 is joined between these two reinforcing members 32 and 32. The two joints between the reinforcing members 32 and the intermediate reinforcing member 34 are designated as vulnerable sites 33.

The configuration of the cross member main body 31 in this case is the same as that of the cross member main body 31 in the embodiment illustrated in FIGS. 2 to 4. As illustrated in FIG. 10, the intermediate reinforcing member 34 has a bottom surface 341 and vertical wall surfaces 342 rising from this bottom surface 341, and has the same cross-sectional shape as the reinforcing member 32. As illustrated in FIG. 9, the reinforcing members 32 and intermediate reinforcing member 34 of the present embodiment are joined by welding or the like in a state in which the bottom surfaces 321 of the reinforcing members 32 and the bottom surface 341 of the intermediate reinforcing member 32 are in contact with the bottom surface 311 of the cross member main body 31 in the range R1 of the flat bottom surface 311 of the cross member main body 31. The reinforcing member 32 according to the present invention may be a flat sheet-like member composed only of the bottom surface 321, without the vertical wall surfaces 322. Likewise, the intermediate reinforcing member 34 according to the present invention may be a flat sheet-like member composed only of the bottom surface 341 and no vertical wall surfaces 342.

Note, however, that in the present embodiment, each reinforcing member 32 itself and the intermediate reinforcing member 32 itself do not have a vulnerable site 33; instead, the two joints between the reinforcing members 32 and the intermediate reinforcing member 34 are serve as vulnerable sites 33. Here, it is more preferred to provide the vulnerable sites 33 and 33, which are the two joints between the reinforcing members 32 and the intermediate reinforcing member 34, more inward in the vehicle width direction than the rising start positions 132 of the tunnel portion 131 of the floor panel 13, as illustrated in FIG. 9, that is, in the range indicated by the symbol R2.

The reinforcing members 32 and intermediate reinforcing member 34 of the present embodiment are members with different sheet thicknesses or materials. A single steel sheet (blank material) made by welding together two or more steel sheets of different sheet thicknesses or materials is also called a tailored blank. For example, in the present embodiment, the two reinforcing members 32 can be made from thick steel sheets, and the intermediate reinforcing member 34 can be made from a thin steel sheet, with their end portions welded together. Alternatively, the two reinforcing members 32 can be made from steel material, and the intermediate reinforcing member 34 can be made from aluminum material of the same sheet thickness, with their end portions welded together.

Then, as illustrated in FIG. 9, when the two reinforcing members 32 are provided spaced apart on the left and right of the cross member main body 31 in the vehicle width direction, and an intermediate reinforcing member 34 made of a different material or thickness is joined between the reinforcing members 32 and 32, with these joints designated as the vulnerable sites 33, the buckling deformation load of the entire cross member 3 in response to the input in the vehicle width direction, such as in a side collision, will be relatively smaller at the joints between the reinforcing members 32 and the intermediate reinforcing member 34, that is, the vulnerable sites 33, than at the portions in which the reinforcing members 32 and intermediate reinforcing member 34 are provided. Furthermore, because the two reinforcing members 32 and 32 and the intermediate reinforcing member 34 are provided in the lower portion of the cross member main body 31, the buckling deformation load of the entire cross member 3 will be relatively smaller in the lower portion in a cross section perpendicular to the extending direction of the cross member than in the upper portion. As a result, when a force F is input in the vehicle width direction, such as in a side collision, the reinforcing members 32 and the intermediate reinforcing member 34 undergo upward convex buckling deformation from the vulnerable sites 33 as starting points. This can suppress the interference of vehicle structures with the battery case 21 during a side collision.

### Actions and Effects of Embodiments

As described above, the vehicle underbody structure of the present embodiment includes: a floor panel 13 constituting a floor surface of a vehicle 1; a pair of side sills 14, 14 arranged on left and right sides of the floor panel 13; a cross member 3 provided on an exterior surface of the floor panel 13 and including a flat extending bottom surface 311, the cross member 3 extending in a vehicle width direction to connect the pair of side sills 14, 14; and a battery case 21 disposed below the floor panel 13 and the cross member 3 and accommodating a battery, wherein a vulnerable site 33 is provided in a lower portion of the cross member 3 in a cross section perpendicular to an extending direction of the cross member 3, and the vulnerable site 33 has a smaller buckling deformation load in response to an input in the vehicle width direction than the upper portion; therefore, when an input such as a side collision occurs, stress is concentrated at the vulnerable site 33. When an input such as a side collision occurs, the cross member 3 undergoes downward convex buckling deformation, starting from the vulnerable site 33 provided in the lower portion. This can suppress the interference of the vehicle structures with the battery case 21.

Moreover, in the vehicle underbody structure of the present embodiment, when a load in the vehicle width direction is input to the vehicle 1, the cross member 3 undergoes upward convex buckling deformation from the vulnerable site 33 as a starting point, and it is therefore possible to suppress the interference of the vehicle structures with the battery case 21.

Furthermore, in the vehicle underbody structure of the present embodiment, the cross member 3 includes a reinforcing member 32 extending in the vehicle width direction on the flat extending bottom surface 311, and the vulnerable site 33 is provided in a lower portion of the reinforcing member 32 in a cross section perpendicular to an extending direction of the reinforcing member 32; therefore, when an input such as a side collision occurs, the reinforcing member 32 undergoes upward convex buckling deformation starting from the vulnerable site 33 provided in the lower portion, and simultaneously, the entire cross member 3 undergoes upward convex buckling deformation. This can suppress the interference of the vehicle structures with the battery case 21.

In addition, in the vehicle underbody structure of the present embodiment, the reinforcing member 32 comprises reinforcing members that are provided spaced apart on left and right in the vehicle width direction, and the vulnerable site 33 is composed of a space between the reinforcing members 32; therefore, when an input such as a side collision occurs, the reinforcing member 32 undergoes upward convex buckling deformation from the vulnerable site 33 as a starting point, particularly from the inner end portion of the reinforcing member 32 at which the magnitude of the buckling deformation load changes rapidly, and simultaneously, the entire cross member 3 undergoes upward convex buckling deformation. This can suppress the interference of the vehicle structures with the battery case 21.

Moreover, in the vehicle underbody structure of the present embodiment, the reinforcing member 32 comprises reinforcing members that are provided in contact with left and right in the vehicle width direction, and the vulnerable site 33 comprises vulnerable sites that are provided in respective end portions of the reinforcing members 32 in contact with each other; therefore, when an input such as a side collision occurs, the two reinforcing members 32 undergo upward convex buckling deformation, starting from the vulnerable sites 33 provided at the contact portions, and simultaneously, the entire cross member 3 undergoes upward convex buckling deformation. This can suppress the interference of the vehicle structures with the battery case 21. At this time, the two reinforcing members 32 and 32 are merely in contact with each other but are not joined, so no tensile force f is generated between these two reinforcing members 32 and 32. As such, the buckling deformation can be more reliably achieved at the intended position.

Furthermore, in the vehicle underbody structure of the present embodiment, the cross member 3 includes reinforcing members 32 and an intermediate reinforcing member 34 that extend in the vehicle width direction on the flat extending bottom surface 311, the reinforcing members 32 are provided spaced apart on left and right in the vehicle width direction, the intermediate reinforcing member 34 is joined between the reinforcing members 32, 32 on the left and right, and joints between the reinforcing members 32 and the intermediate reinforcing member 34 constitute the vulnerable site 33; therefore, when an input such as a side collision occurs, the reinforcing members 32 and the intermediate reinforcing member 34 undergo upward convex buckling deformation from the vulnerable sites 33 as the starting points, and simultaneously, the entire cross member 3 undergoes upward convex buckling deformation. This can suppress the interference of the vehicle structures with the battery case 21.

In addition, in the vehicle underbody structure of the present embodiment, the vulnerable site 33 is provided in a range R more inward in the vehicle width direction than a rising start position 132 of a tunnel portion 131 of the floor panel 13; therefore, when an input such as a side collision occurs, the floor panel 13 undergoes upward convex buckling deformation following the shape of the tunnel portion 131. This buckling deformation of the floor panel 13 can complement the upward convex buckling deformation of the entire cross member 3.

Moreover, in the vehicle underbody structure of the present embodiment, the position P1 of one outer end portion of the reinforcing member 32 is provided more inward in the vehicle width direction than the position P2 of an outer end portion of the battery case 21. When an input such as a side collision occurs, the side sill 14 and the left end portion of the cross member main body 31 will collapse to absorb the collision energy, but by locating the left end position P1 of the reinforcing member 32 closer to the center in the vehicle width direction than the outer left end position P2 of the battery case 21, it is possible to sufficiently absorb the collision energy by the collapse of the side sill 14 and the left end portion of the cross member main body 31. It is also possible to prevent the cross member 3 from prematurely initiating buckling deformation in the early stages of the side collision.

1. A vehicle underbody structure comprising:
a floor panel constituting a floor surface of a vehicle;
a pair of side sills arranged on left and right sides of the floor panel;
a cross member provided on an exterior surface of the floor panel and including a flat extending bottom surface, the cross member extending in a vehicle width direction to connect the pair of side sills; and
a battery case disposed below the floor panel and the cross member and accommodating a battery,
wherein a vulnerable site is provided in a lower portion of the cross member in a cross section perpendicular to an extending direction of the cross member.

2. The vehicle underbody structure according to claim 1, wherein
when a load in the vehicle width direction is input to the vehicle, the cross member undergoes upward convex buckling deformation from the vulnerable site as a starting point.

3. The vehicle underbody structure according to claim 1, wherein
the cross member includes a reinforcing member extending in the vehicle width direction on the flat extending bottom surface, and
the vulnerable site is provided in a lower portion of the reinforcing member in a cross section perpendicular to an extending direction of the reinforcing member.

4. The vehicle underbody structure according to claim 3, wherein
the reinforcing member comprises reinforcing members that are provided spaced apart on left and right in the vehicle width direction, and
the vulnerable site is composed of a space between the reinforcing members.

5. The vehicle underbody structure according to claim 3, wherein
the reinforcing member comprises reinforcing members that are provided in contact with left and right in the vehicle width direction, and
the vulnerable site comprises vulnerable sites that are provided in respective end portions of the reinforcing members in contact with each other.

6. The vehicle underbody structure according to claim 1, wherein
the cross member includes reinforcing members and an intermediate reinforcing member that extend in the vehicle width direction on the flat extending bottom surface,
the reinforcing members are provided spaced apart on left and right in the vehicle width direction,
the intermediate reinforcing member is joined between the reinforcing members on the left and right, and
joints between the reinforcing members and the intermediate reinforcing member constitute the vulnerable site.

7. The vehicle underbody structure according to claim 1, wherein
the vulnerable site is provided more inward in the vehicle width direction than a rising start position of a tunnel portion of the floor panel.

8. The vehicle underbody structure according to claim 3, wherein
one outer end portion of the reinforcing member is provided more inward in the vehicle width direction than an outer end portion of the battery case.
